(19) United States
(12) Patent Application Publication
(10) Pub. No.: US 2021/0109065 A1
(43) Pub. Date: Apr. 15, 2021

(54) WELL TOOL FOR MEASURING ACOUSTIC VELOCITY

(71) Applicant: Halliburton Energy Services, Inc., Houston, TX (US)

(72) Inventors: Ricardo Ortiz, Houston, TX (US); Grant Phillip Goodyear, Spring, TX (US)

(73) Assignee: Halliburton Energy Services, Inc., Houston, TX (US)

(21) Appl. No.: 16/600,801

(22) Filed: Oct. 14, 2019

(51) Int. Cl. G01N 29/024; G01V 1/50; E21B 47/01

(52) U.S. Cl. CPC G01N 29/024; E21B 47/01; G01V 1/50

(57) ABSTRACT

A well tool for use within a borehole with borehole fluid. The well tool may include a body, an acoustic velocity transducer, a reflector plate, and a processor. The body may include a fluid conduit extending between a flow inlet and a flow outlet. The flow inlet and the flow outlet may be positioned on an exterior of the body to allow the borehole fluid to pass through the fluid conduit. The acoustic velocity sensor may be positioned within the fluid conduit and configured to generate and receive an acoustic pulse. The reflector plate may be positioned within the fluid conduit such that the pulse is reflected off of the reflector plate back to the acoustic velocity transducer. The processor may be programmed to determine an acoustic velocity of the borehole fluid based on a return time of the pulse reflected back from the reflector plate.

### BACKGROUND

This section is intended to provide relevant background information to facilitate a better understanding of the various aspects of the described embodiments. Accordingly, these statements are to be read in this light and not as admissions of prior art.

The use of acoustic measurement systems (e.g., audible and/or ultrasonic systems) in downhole applications, such as logging-while-drilling (LWD), measurement while drilling (MWD), and wireline logging applications, is well known. Such acoustic measurement systems are utilized in a variety of downhole applications including, for example, borehole caliper measurements, measurement of borehole fluid properties, and the determination of various physical properties of a geologic formation.

Acoustic waveforms may be generated at one or more transmitters deployed in the borehole. The acoustic responses may then be received at the transmitter that generated the acoustic waveform or at one or more receivers longitudinally spaced apart from the transmitter and deployed within the borehole. Acoustic logging in this manner provides an important set of borehole data and is commonly used in MWD, LWD, and wireline applications.

The speed of sound within a borehole fluid, also known as the acoustic velocity of the borehole fluid, is a factor in such measurements. Further, several parameters, such as, but not limited to, viscosity, density, pressure, temperature, and the presence of borehole cuttings within the borehole fluid affect the acoustic velocity of the fluid. However, current techniques often rely upon an estimated acoustic velocity of the borehole fluid, which does not account for one or more of the parameters listed above.

### BRIEF DESCRIPTION OF THE DRAWINGS

Embodiments of the well tool are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a cross-sectional diagram of a drilling system, according to one or more embodiments;

FIG. 2 is a cross-sectional diagram of well tool for measuring acoustic velocity, according to one or more embodiments; and

FIG. 3 is a perspective view of a section of a bottom hole assembly, according to one or more embodiments.

### DETAILED DESCRIPTION

The present disclosure describes a well tool for measuring acoustic velocity. The well tool determines the acoustic velocity of the borehole fluid at the well tool. This allows the operator to utilize the actual acoustic velocity of the borehole fluid instead of an estimated acoustic velocity when drilling a borehole.

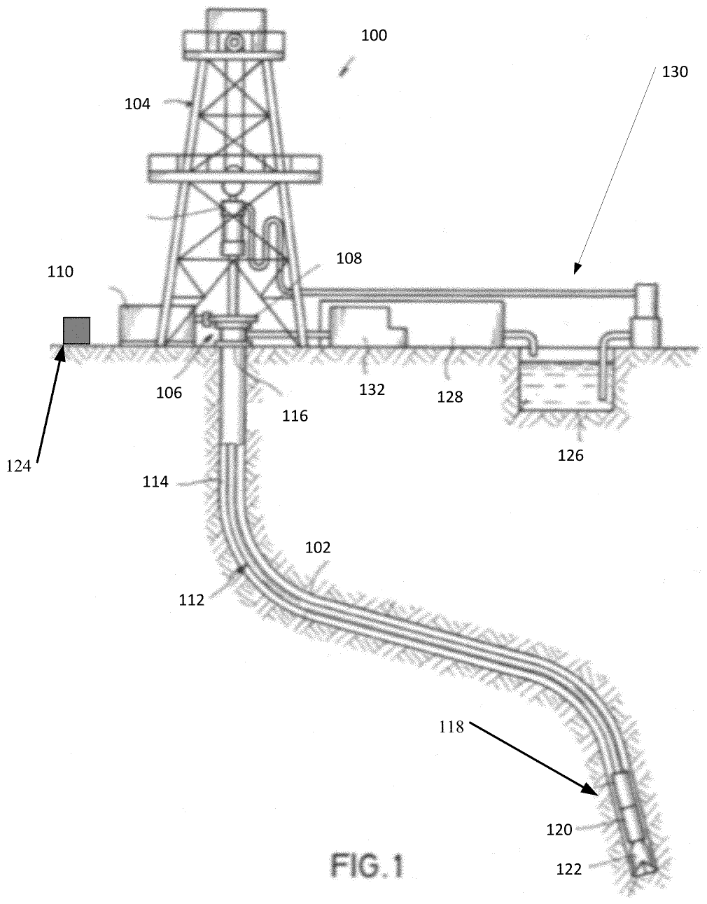

FIG. 1 is a cross-sectional view of a drilling system 100 to develop a crude oil and well-gas source. The drilling system 100 forms a borehole 102 extending through various earth strata in an oil and gas formation located below the earth's surface. As shown, the drilling system 100 includes a drilling rig 104, such as the land drilling rig shown in FIG. 1. The drilling system 100 may also be deployed on offshore platforms, semi-submersibles, drillships, and the like.

As shown, a borehole 102 may be formed in a vertical or substantially vertical orientation relative to a surface of the well. Although not shown, it is known by those of ordinary skill in the art that a lateral borehole may in some instances be formed in a horizontal or substantially horizontal orientation relative to the surface of the well. However, reference herein to either the main borehole or the lateral borehole is not meant to imply any particular orientation, and the orientation of each of these boreholes may include portions that are vertical, non-vertical, horizontal or non-horizontal. Further, the term “uphole” refers a direction that is towards a wellhead of a well, while the term “downhole” refers a direction that is away from the wellhead. Further, as shown, the borehole 102 may not be entirely substantially vertical but in some areas may deviate at an angle from vertical and even possibly return to vertical at a later portion.

The drilling rig 104 is shown located proximate to a wellhead 106. However, the drilling rig 104 may be spaced apart from a wellhead, such as in the case of an offshore arrangement. The drilling rig 104 includes a rotary table 108, a rotary drive motor 110, and other equipment associated with rotation and translation of a drillstring 112 within the borehole 102. An annulus 114 is formed between the exterior of the drillstring 112 and the inside wall of the borehole 102. A pressure control device, such as a blowout preventer 116, and other equipment associated with drilling a borehole 102 are also provided at the wellhead 106 but are not always required.

The lower end of the drillstring 112 may include a bottom hole assembly (BHA) 118, which carries at a distal end a drill bit 122. The BHA 118 includes a well tool 120 for measuring the acoustic velocity of borehole fluid, as described in more detail below, and may be in communication with a control system 124 on the surface.

Drilling fluid or “mud” is pumped from a fluid reservoir 126 by a mud pump 128 to the upper end of the drillstring 112 and flows through the longitudinal interior of the drillstring 112, through BHA 118, and exits from nozzles in the drill bit 122. At the downhole end of borehole 102, drilling fluid may mix with formation cuttings and other downhole fluids and debris. The drilling fluid mixture then flows upwardly through the annulus 114 to return formation cuttings and other downhole debris to the surface.

After exiting the borehole 102, the slurry flows to a slurry treatment system 130 including a shale shaker 132. The shale shaker 132 separates the solids within the slurry from the liquid by passing the liquid through shaker screens (not shown) to filter the solids from the liquid. The liquid may be further treated and/or filtered in the slurry treatment system 130 using methods known to skilled in the art separate water, oil, and non-gas liquid hydrocarbons. The output of the slurry treatment system 130, i.e., drilling fluid, flows through piping into the fluid reservoir 126 for reuse within the borehole 102.

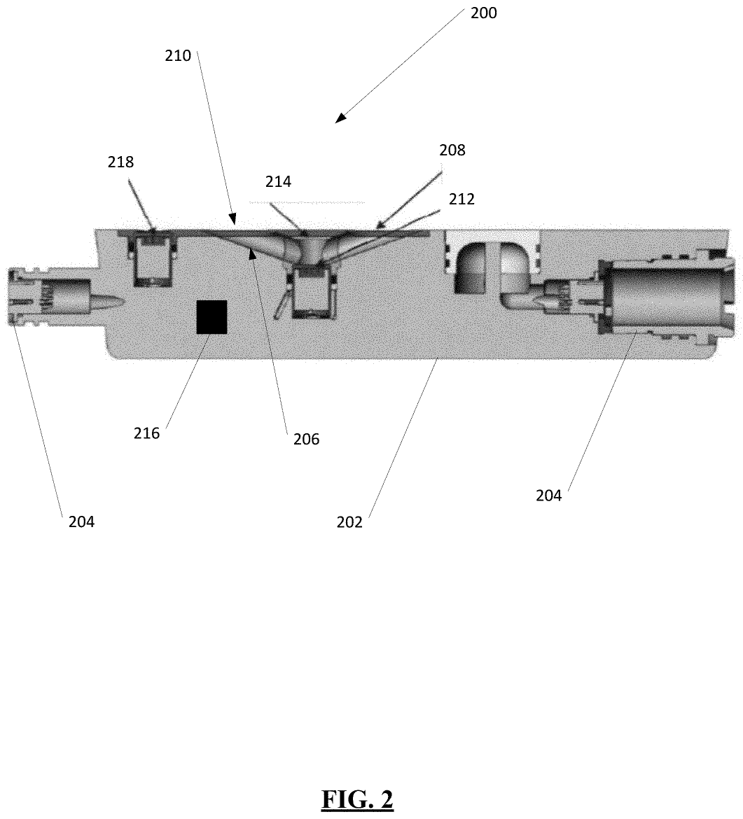

FIG. 2 is a cross-sectional diagram of a well tool 200 for measuring acoustic velocity, according to one or more embodiments. As previously discussed, the well tool 200 is coupled to the exterior of a BHA, such as BHA 118 shown in FIG. 1. A body 202 of the well tool 200 may be coupled to the BHA 118 using bolts, welding, or any other means known to those skilled in the art. Additionally, the well tool 200 is in electrical communication with the BHA 118 via one or more electrical connectors 204. Although the well tool 200 is shown as including two electrical connectors, the well tool 200 is not thereby limited and may include any number of electrical connectors 204.

The body 202 of the well tool 200 includes a fluid conduit 206 extending between a flow inlet 208 and a flow outlet 210 positioned on the exterior of the body 202. The fluid conduit 206 allows borehole fluid at the well tool 200 to pass through well tool 200 once the well tool 200 is positioned within a borehole, such as borehole 102 shown in FIG. 1.

An acoustic velocity transducer 212 and a reflector plate 214 are positioned within the fluid conduit 206 and are used to determine the acoustic velocity of the borehole fluid at the well tool 200. The reflector plate is positioned at a known distance from the acoustic velocity transducer 212. The acoustic velocity transducer 212 generates an acoustic pulse that is reflected off of the reflector plate 214 back to and is received by the acoustic velocity transducer 212. The acoustic velocity transducer 212 also detects a change in amplitude of the acoustic pulse between the generated acoustic pulse and the reflected acoustic pulse.

The well tool 200 further includes a computing device 216 in electronic communication with the acoustic velocity transducer 212. The computing device 216 includes a processor, memory, e.g., random access memory, and persistent storage, e.g., disk drives, solid state drives, etc. The persistent storage may store computer instructions, e.g., computer code, that, when executed by the processor of the computing device, determine the acoustic velocity of the borehole fluid. The determination of the acoustic velocity of the borehole fluid is based on the known distance between the acoustic velocity transducer 212 and the reflector plate 214, and a return time of the acoustic pulse, which is the time between generating the acoustic pulse and receiving the reflected acoustic pulse. The computing device 216 can then determine the density of the borehole fluid based on the acoustic velocity of the borehole fluid and the change in amplitude of the acoustic pulse.

Monitoring the density of the borehole fluid via the acoustic velocity transducer 212 can allow an operator to determine the effectiveness of a borehole cleaning operation. When determining the effectiveness of a borehole cleaning operation, an additional transducer is used to measure fluid density of fluid passing through an internal bore of the BHA 118. Alternatively, an approximate density of fluid passing through an internal bore of the BHA 118 can be estimated based on pressure, temperature, mud weight, and mud type. A ratio of the borehole fluid density to the density of fluid passing through an internal bore of the BHA 118 of greater than 1.00 indicates the borehole cleaning operation is at least partially effective.

Although shown in the well tool 200, the computing device 216 may alternatively be located elsewhere in the BHA 118 or within a control system, such as control system 124, located at the surface. In such cases, the readings from the acoustic velocity transducer 212 may be communicated uphole via mud pulse telemetry or other methods known to those skilled in the art.

As shown in FIG. 2, at least one embodiment of the well tool 200 includes a stand-off transducer 218. In other embodiments, the stand-off transducer 218 may be omitted. The stand-off transducer 218 functions similarly to the acoustic velocity transducer 212, generating an acoustic pulse that is reflected of a surface back to and is received by the stand-off transducer 218. The stand-off transducer 218 is positioned on the exterior of the well tool 200 such that an acoustic pulse generated by the stand-off transducer 218 is reflected off the borehole wall.

The stand-off transducer 218 is in electronic communication with the computing device 216 that determines the distance between the stand-off transducer 218 and the borehole wall based on the measurements received from the acoustic velocity transducer 212 and the stand-off transducer 218. The computing device 216 determines the acoustic velocity of the borehole fluid, as described above. Once the acoustic velocity of the borehole fluid is known, the return time of the acoustic pulse generated by the stand-off transducer 218 can be used to accurately determine the distance between the stand-off transducer 218 and the borehole wall.

In some embodiments, the BHA 118 also includes density or neutron porosity tools that interrogate formation properties by emitting radiation from the tool into the formation and detecting the properties of the formation by analyzing the radiation that returns to the tool. However, the radiation is affected by both the distance between the density or neutron porosity tool and the borehole wall, as well as the density of the borehole fluid. The acoustic velocity and distance measurements obtained with the well tool 200 can be used to calculate a correction factor for the density or neutron porosity tools, increasing the accuracy of the density or neutron porosity tools.

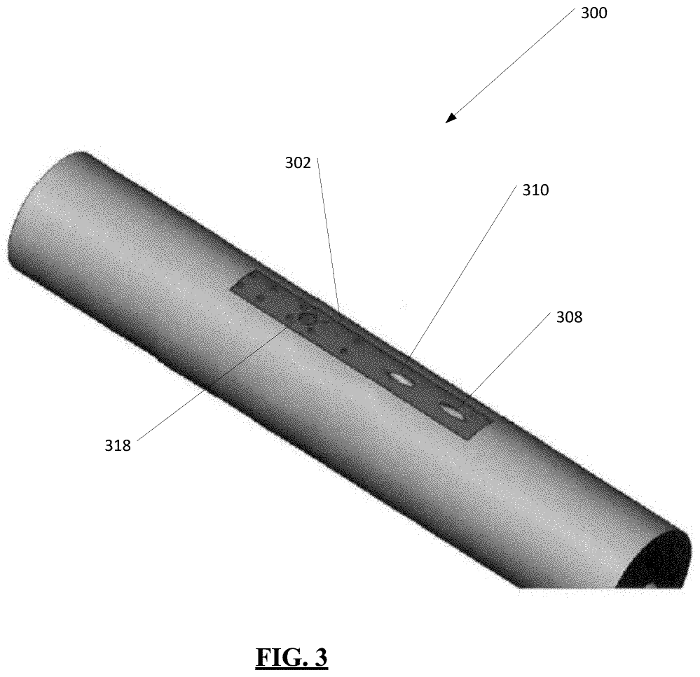

FIG. 3 is a perspective view a section 300 of a BHA, such as BHA 118 described above with reference to FIG. 1, according to one or more embodiments. The section 300 of the BHA 118 includes many elements that are similar to the elements described above in relation to the well tool 200 shown in FIG. 2. Further, the functions of these elements are similar to those described above in relation to the well tool 200 shown in FIG. 2. Accordingly, similar elements will not be described again in detail, except as where necessary for the understanding of the section 300 of the BHA 118 shown in FIG. 3.

As shown in FIG. 3, the section 300 includes a flow inlet 308 and a flow outlet 310 formed in a cover plate 302 and connected by a fluid conduit 206, as shown in FIG. 2. Additionally, the cover plate 302 forms a portion of the walls of the fluid conduit 206 and is coupled to and positioned on the exterior of the section 300 of the BHA 118 to allow borehole fluid to pass through the fluid conduit 206. As described above, an acoustic velocity transducer 212 is positioned within the fluid conduit 206 opposite a reflector plate 214.

The section 300 of the BHA 118 may also include a stand-off transducer 318 that is retained in position within the section 300 by the cover plate 302. Similar to the well tool 200, the stand-off transducer 318 and the acoustic velocity transducer 212 are in electronic communication with a processor located within the BHA 118 or within a control system, such as control system 124, at the surface. The processor is programmed to determine and determines the acoustic velocity of the borehole fluid, the density of the borehole fluid, and the distance between the stand-off transducer 318 and the borehole wall.

Further examples include:

Example 1 is a well tool for use within a borehole with borehole fluid. The well tool includes a body, an acoustic velocity transducer, a reflector plate, and a processor. The body includes a fluid conduit extending between a flow inlet and a flow outlet. The flow inlet and the flow outlet are positioned on an exterior of the body to allow the borehole fluid to pass through the fluid conduit. The acoustic velocity sensor is positioned within the fluid conduit and configured to generate and receive an acoustic pulse. The reflector plate is positioned within the fluid conduit such that the acoustic pulse generated by the acoustic velocity transducer is reflected off of the reflector plate back to the acoustic velocity transducer. The processor is in electronic communication with the acoustic velocity transducer and programmed to determine an acoustic velocity of the borehole fluid based on a return time of the acoustic pulse generated by the acoustic velocity transducer and reflected back from the reflector plate.

In Example 2, the embodiments of any preceding paragraph or combination thereof further include wherein the processor is further programmed to determine a density of the borehole fluid based on the return time and an amplitude of the acoustic pulse after the acoustic pulse reflects off of the reflector plate.

In Example 3, the embodiments of any preceding paragraph or combination thereof further include a stand-off transducer positioned to reflect an acoustic pulse off of a wall of the borehole and back to the stand-off transducer.

In Example 4, the embodiments of any preceding paragraph or combination thereof further include wherein the processor is further programmed to determine a distance between the well tool and the borehole wall based on the acoustic velocity of the borehole fluid and a return time of an acoustic pulse generated by the stand-off transducer and reflected off the borehole wall.

Example 5 is a drilling system for drilling a borehole with borehole fluid in the borehole. The drilling system includes a drillstring, a well tool coupled to the drillstring, and a processor. The well tool includes a body, an acoustic velocity transducer, and a reflector plate. The body includes a fluid conduit extending between a flow inlet and a flow outlet. The flow inlet and the flow outlet are positioned on an exterior of the body to allow the borehole fluid to pass through the fluid conduit. The acoustic velocity sensor is positioned within the fluid conduit and configured to generate and receive an acoustic pulse. The reflector plate is positioned within the fluid conduit such that the acoustic pulse generated by the acoustic velocity transducer is reflected off of the reflector plate back to the acoustic velocity transducer. The processor is in electronic communication with the acoustic velocity transducer and programmed to determine an acoustic velocity of the borehole fluid based on a return time of the acoustic pulse generated by the acoustic velocity transducer and reflected back from the reflector plate.

In Example 6, the embodiments of any preceding paragraph or combination thereof further include wherein the processor is further configured to determine a density of the borehole fluid based on the return time and an amplitude of the acoustic pulse after the acoustic pulse reflects off of the reflector plate.

In Example 7, the embodiments of any preceding paragraph or combination thereof further include a BHA coupled to the drillstring, wherein the well tool is coupled to the BHA.

In Example 8, the embodiments of any preceding paragraph or combination thereof further include wherein the BHA includes a stand-off transducer positioned to reflect an acoustic pulse off of a wall of the borehole and back to the stand-off transducer.

In Example 9, the embodiments of any preceding paragraph or combination thereof further include wherein the processor is further programmed to determine a distance between the BHA and the borehole wall based on the acoustic velocity of the borehole fluid and a return time of an acoustic pulse generated by the stand-off transducer and reflected off of the borehole wall.

In Example 10, the embodiments of any preceding paragraph or combination thereof further include wherein the well tool further includes a stand-off transducer is positioned to reflect an acoustic pulse off of a wall of the borehole and back to the stand-off transducer.

In Example 11, the embodiments of any preceding paragraph or combination thereof further include wherein the processor is further programmed to determine a distance between the well tool and the borehole wall based on the acoustic velocity of the borehole fluid and a return time of an acoustic pulse generated by the stand-off transducer and reflected off of the borehole wall.

In Example 12, the embodiments of any preceding paragraph or combination thereof further include wherein the processor is located within the well tool.

In Example 13, the embodiments of any preceding paragraph or combination thereof further include a BHA, wherein the processor is located within the BHA.

In Example 14, the embodiments of any preceding paragraph or combination thereof further include wherein the processor is located at the surface.

Example 15 is a method of drilling a borehole. The method includes positioning a well tool within the borehole. The method also includes flowing borehole fluid through a fluid conduit extending between a flow inlet and a flow outlet, the flow inlet and the flow outlet positioned on an exterior of the well tool. The method further includes generating an acoustic pulse by an acoustic velocity transducer positioned within the fluid conduit and reflecting the acoustic pulse off a reflector plate positioned within the fluid conduit back to the acoustic velocity transducer. The method also includes determining a return time of the acoustic pulse back to the acoustic velocity transducer. The method further includes determining an acoustic velocity of the borehole fluid based on the return time.

In Example 16, the embodiments of any preceding paragraph or combination thereof further include generating an acoustic pulse with a stand-off transducer and reflecting the acoustic pulse off a borehole wall back to the stand-off transducer. The method also includes determining the return time of the acoustic pulse back to the stand-off transducer. The method further includes determining either a distance between the well tool and a borehole wall or a distance between a BHA and the borehole wall based on the acoustic velocity of the borehole fluid and the return time of the acoustic pulse reflected off of the borehole wall.

In Example 17, the embodiments of any preceding paragraph or combination thereof further include determining a density of the borehole fluid based on an amplitude of the acoustic pulse after the acoustic pulse reflects off of the reflector plate and the return time.

In Example 18, the embodiments of any preceding paragraph or combination thereof further include determining a correction factor to at least one of a density tool of the BHA or a neutron porosity tool of the BHA based the density of the borehole fluid and either the distance between the well tool and the borehole wall or the distance between a BHA and the borehole wall.

In Example 19, the embodiments of any preceding paragraph or combination thereof further include determining a density of the borehole fluid based on an amplitude of the acoustic pulse after the acoustic pulse reflects off of the reflector plate and the return time. The method also includes determining an effectiveness of a borehole cleaning operation based on the density of the borehole fluid.

In Example 20, the embodiments of any preceding paragraph or combination thereof further include communicating the acoustic velocity of the borehole fluid uphole.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A well tool for use within a borehole with borehole fluid, the well tool comprising:
a body comprising a fluid conduit extending between a flow inlet and a flow outlet, the flow inlet and the flow outlet positioned on an exterior of the body to allow the borehole fluid to pass through the fluid conduit;
an acoustic velocity transducer positioned within the fluid conduit and configured to generate and receive an acoustic pulse;
a reflector plate positioned within the fluid conduit such that the acoustic pulse generated by the acoustic velocity transducer is reflected off of the reflector plate back to the acoustic velocity transducer; and
a processor in electronic communication with the acoustic velocity transducer, the processor programmed to determine an acoustic velocity of the borehole fluid based on a return time of the acoustic pulse generated by the acoustic velocity transducer and reflected back from the reflector plate.

2. The well tool of claim 1, wherein the processor is further programmed to determine a density of the borehole fluid based on the return time and an amplitude of the acoustic pulse after the acoustic pulse reflects off of the reflector plate.

3. The well tool of claim 1, further comprising a stand-off transducer positioned to reflect an acoustic pulse off of a wall of the borehole and back to the stand-off transducer.

4. The well tool of claim 3, wherein the processor is further programmed to determine a distance between the well tool and the borehole wall based on the acoustic velocity of the borehole fluid and a return time of an acoustic pulse generated by the stand-off transducer and reflected off the borehole wall.

5. A drilling system for drilling a borehole with borehole fluid in the borehole, comprising;
a drillstring;
a well tool coupled to the drillstring and comprising:
a body comprising a fluid conduit extending between a flow inlet and a flow outlet, the flow inlet and the flow outlet positioned on an exterior of the body to allow the borehole fluid to pass through the fluid conduit;
an acoustic velocity transducer positioned within the fluid conduit and configured to generate and receive an acoustic pulse; and
a reflector plate positioned within the fluid conduit such that the acoustic pulse generated by the acoustic velocity transducer is reflected off of the reflector plate back to the acoustic velocity transducer; and
a processor in electronic communication with the acoustic velocity transducer, the processor programmed to determine an acoustic velocity of the borehole fluid based on a return time of the acoustic pulse generated by the acoustic velocity transducer and reflected back from the reflector plate.

6. The drilling system of claim 5, wherein the processor is further configured to determine a density of the borehole fluid based on the return time and an amplitude of the acoustic pulse after the acoustic pulse reflects off of the reflector plate.

7. The drilling system of claim 5, further comprising a BHA coupled to the drillstring, wherein the well tool is coupled to the BHA.

8. The drilling system of claim 7, wherein the BHA comprises a stand-off transducer positioned to reflect an acoustic pulse off of a wall of the borehole and back to the stand-off transducer.

9. The drilling system of claim 8, wherein the processor is further programmed to determine a distance between the BHA and the borehole wall based on the acoustic velocity of the borehole fluid and a return time of an acoustic pulse generated by the stand-off transducer and reflected off of the borehole wall.

10. The drilling system of claim 5, wherein the well tool further comprises a stand-off transducer is positioned to reflect an acoustic pulse off of a wall of the borehole and back to the stand-off transducer.

11. The well tool of claim 10, wherein the processor is further programmed to determine a distance between the well tool and the borehole wall based on the acoustic velocity of the borehole fluid and a return time of an acoustic pulse generated by the stand-off transducer and reflected off of the borehole wall.

12. The drilling system of claim 5, wherein the processor is located within the well tool.

13. The drilling system of claim 5, further comprising a BHA, wherein the processor is located within the BHA.

14. The drilling system of claim 5, wherein the processor is located at the surface.

15. A method of drilling a borehole, the method comprising:
positioning a well tool within the borehole;
flowing borehole fluid through a fluid conduit extending between a flow inlet and a flow outlet, the flow inlet and the flow outlet positioned on an exterior of the well tool;
generating an acoustic pulse by an acoustic velocity transducer positioned within the fluid conduit and reflecting the acoustic pulse off a reflector plate positioned within the fluid conduit back to the acoustic velocity transducer;
determining a return time of the acoustic pulse back to the acoustic velocity transducer; and
determining an acoustic velocity of the borehole fluid based on the return time.

16. The method of claim 15, further comprising:
generating an acoustic pulse with a stand-off transducer and reflecting the acoustic pulse off a borehole wall back to the stand-off transducer;
determining the return time of the acoustic pulse back to the stand-off transducer; and
determining either a distance between the well tool and a borehole wall or a distance between a BHA and the borehole wall based on the acoustic velocity of the borehole fluid and the return time of the acoustic pulse reflected off of the borehole wall.

17. The method of claim 16, further comprising determining a density of the borehole fluid based on an amplitude of the acoustic pulse after the acoustic pulse reflects off of the reflector plate and the return time.

18. The method of claim 17, further comprising determining a correction factor to at least one of a density tool of the BHA or a neutron porosity tool of the BHA based the density of the borehole fluid and either the distance between the well tool and the borehole wall or the distance between a BHA and the borehole wall.

19. The method of claim 15, further comprising:
determining a density of the borehole fluid based on an amplitude of the acoustic pulse after the acoustic pulse reflects off of the reflector plate and the return time; and
determining an effectiveness of a borehole cleaning operation based on the density of the borehole fluid.

20. The method of claim 15, further comprising communicating the acoustic velocity of the borehole fluid uphole.
